(19) United States
(12) Patent Application Publication
(10) Pub. No.: US 2008/0063182 A1
(43) Pub. Date: Mar. 13, 2008

(54) Voice device

(75) Inventor: Kuan-Di Huang, Taoyuan County (TW)

Correspondence Address: BACON & THOMAS, PLLC, 625 SLATERS LANE, FOURTH FLOOR, ALEXANDRIA, VA, 22314, US

(73) Assignees: Kuan-Di Huang, Taoyuan County (TW); HALLOA ENTERPRISE CO., LTD., Sanchong City (TW)

(21) Appl. No.: 11/501,807

(22) Filed: Aug. 10, 2006

(51) Int. Cl. H04M 1/00

(52) U.S. Cl. 379/433.11

(57) ABSTRACT

The present invention is to provide a voice device, which comprises a sensor unit adapted to generate an idle signal in response to an idle state of the voice device, and a control circuit capable of determining that the voice device is idle after receiving the idle signal and issuing an alert message through a second sound transmission unit for alerting user of any incoming call based on the idle state of the voice device. The control circuit is also capable of determining that the voice device is in use after receiving the use signal, enables the sensor unit generates a use signal, and then commands a first sound transmission unit to play voice. By utilizing this voice device, it is possible of solving the problem of playing an alert message in an excessively reduced volume as experienced by the conventional voice device.

### FIELD OF THE INVENTION

The present invention relates to Internet telephony network and more particularly to a voice device for use with it.

### BACKGROUND OF THE INVENTION

Personal computers (PCs) and the Internet are widely used by people throughout the world. This has greatly improved the living quality of people. A telecommunication technique by utilizing the Internet has been developed by some electronics manufacture. In detail, it involves installing a communication software in each of a plurality of PCs, the communication software being accessible by a communication server connected to the Internet, enabling any PC to connect to another PC through the communication server, and enabling the communication software installed in one PC to establish a connection with that installed in another PC, thereby effecting a voice communication therebetween.

Further, a telephone set using the communication software is also developed by some electronics manufacture by utilizing the telecommunication technique. The telephone set is connected to a sound card of PC. The telephone set is also adapted to be carried by a person (i.e., portable) for receiving the person's voice. Further, voice signals sent from another PC can be received and converted into voice for playing through a speaker of the telephone set. As a result, user of one telephone set may talk with user of another telephone set.

Currently, there are two types of telephone set commercially available.

(i) The first one is an ear held telephone set similar to a typical headphone but having an additional microphone so as to enable it to play voice and receive a user's voice.

(ii) The second one is a tower shaped telephone set including a rectangular housing having a speaker provided at one end and a microphone provided at the other end. The speaker is adapted to play voice and the microphone is adapted to receive a user's voice respectively.

However, both conventional telephone sets including the ear held telephone set and the tower shaped telephone set are monotonous in design (i.e., dull). As such, its sales is very low. Thus, it is desirable to provide a novel voice device having a diversified design in order to stimulate its sales in the market.

### SUMMARY OF THE INVENTION

After considerable research and experimentation, a voice device according to the present invention has been devised so as to overcome the above drawback of the conventional telephone set.

It is an object of the present invention to provide a voice device comprising a first sound transmission unit, a second sound transmission unit, and a sensor unit. The sensor unit is adapted to generate an idle signal in response to an idle state of the voice device. A control circuit of the voice device is capable of determining that the voice device is idle after receiving the idle signal. Next, the control circuit issues an alert message through the second sound transmission unit for alerting user of any incoming call based on the idle state of the voice device. To the contrary, the control circuit is capable of determining that the voice device is in use after receiving the use signal. Then the sensor unit generates a use signal. Next, the control circuit commands the first sound transmission unit to play voice. By utilizing this voice device, it is possible of solving the problem of playing an alert message in an excessively reduced volume as experienced by the conventional voice device.

It is another object of the present invention to provide a voice device including a body and a cover having a lower end hingedly connected to an upper end of the body. The second sound transmission unit is mounted on a top surface of the body. The cover comprises an opening aligned with the location of the second sound transmission unit. Thus, an alert message played by the second sound transmission unit can freely pass the opening to transmit beyond the top surface of the cover. By configuring a hinge connection of the body and the cover, it is possible of realizing a diversified design of the voice device. Moreover, in an open condition of the voice device, means for transmitting sound and means for receiving sound are disposed a spaced relationship each other so as not to interfere with conversation being made.

The above and other objects, features and advantages of the present invention will become apparent from the following detailed description taken with the accompanying drawings.

### BRIEF DESCRIPTION OF THE DRAWINGS

FIG. 1 is a block diagram of a preferred embodiment of voice device according to the invention; and

FIG. 2 is a perspective view of the voice device in an open condition.

### DETAILED DESCRIPTION OF THE PREFERRED EMBODIMENTS

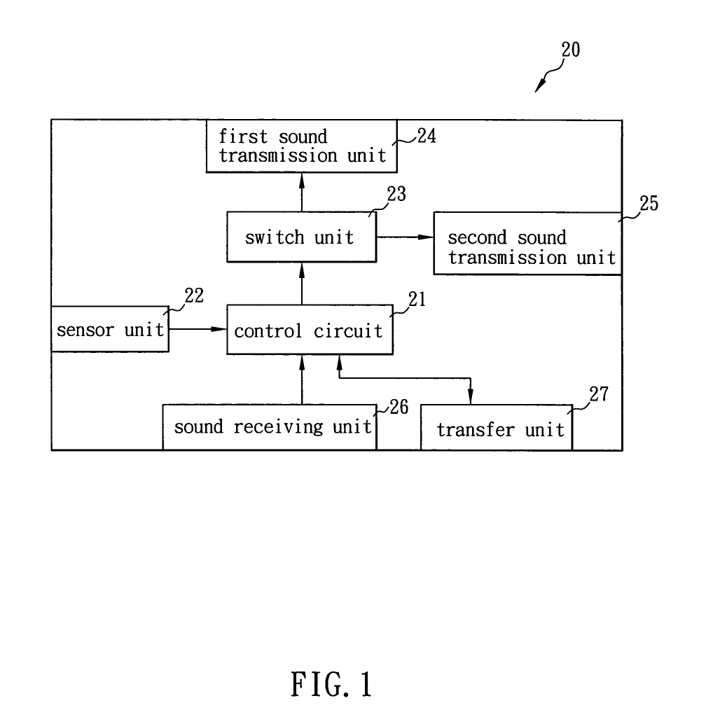

Referring to FIG. 1, a voice device 20 in accordance with a preferred embodiment of the invention comprises a first sound transmission unit 24, a second sound transmission unit 25, and a sensor unit 22. The sensor unit 22 is adapted to generate a use signal or an idle signal in response to a use state or an idle state of the voice device 20. A control circuit 21 of the voice device 20 can determine that the voice device 20 is idle after receiving the idle signal. Next, the control circuit 21 issues an alert message through the second sound transmission unit 25 for alerting user of any incoming call. To the contrary, the control circuit 21 can determine that the voice device 20 is in use after receiving the use signal. Next, the control circuit 21 commands the first sound transmission unit 24 to play voice such that a user of the voice device 20 is able to talk with another user using a telephone. Therefore, by commanding the control circuit 21 to determine a use state or an idle of the voice device 20 in response to a signal received by the control circuit 21 and switching a control between the first sound transmission unit 24 and the second sound transmission unit 25, it is possible of solving the problem of playing an alert message in an excessively reduced volume as experienced by the conventional voice device. Further, it is possible of playing MP3 music when a conversation is not making.

Referring to FIG. 1 again, in the invention the voice device 20 further comprises the control circuit 21, a sound receiving unit 26, a transfer unit 27, the sensor unit 22, a switch unit 23, the first sound transmission unit 24, and the second sound transmission unit 25. Electronic components and circuitry of the voice device 20 are electrically connected to the control circuit 21 such that the voice device 20 may operate normally. The sound receiving unit 26 is electrically connected to the control circuit 21. The sound receiving unit 26 is adapted to receive external audio source (e.g., voice) and convert same into voice signals which are in turn sent to the control circuit 21. As an end, the purpose of sending user voice to the voice device 20 is achieved. The transfer unit 27 is electrically connected to the control circuit 21. The transfer unit 27 is further electrically connected to an electronic device (e.g., computer (not shown)) through a wire or wireless connection (e.g., Bluetooth).

Next, the electronic device (not shown) is connected to a network (e.g., the Internet or a telecommunication network (not shown)). The electronic device has installed a communication software (e.g., Skype). The electronic device is able to identify the voice device 20 by running a driver when the electronic device is electrically connected to the voice device 20. Thereafter, data communication between the voice device 20 and the electronic device is effected. Further, the voice device 20 is capable of accessing the communication software. Thereafter, the electronic device can run the communication software to search over the network. The electronic device is further electrically connected to another electronic device (e.g., computer (not shown)) being used by another user. As such, a user of the voice device 20 can talk with another person using another electronic device via the voice device 20, the electronic device, the network, and another electronic device. Moreover, the running communication software can obtain voice signals (e.g., voice of another user) from another electronic device via the network. Alternatively, voice signals from the voice device 20 are sent to another electronic device for another user to play. In addition, an alert signal (e.g., ring tone, music, or alarm) is generated and sent to the voice device 20 when a request to talk packet sent from another electronic device is received.

Referring to FIG. 1 again, in the invention the sensor unit (e.g., micro-switch, rotatory sensor, or optical sensor) 22 is electrically connected to the control circuit 21. The sensor unit 22 is adapted to generate a corresponding use signal or a corresponding idle signal in response to an on or off state of the voice device 20. The use signal or idle signal is then sent to the control circuit 21. The control circuit 21 thus can determine that the voice device 20 is in use after receiving the use signal and generate a corresponding first switch signal. To the contrary, the control circuit 21 can determine that the voice device 20 is idle after receiving the idle signal and generate a corresponding second switch signal. The switch unit 23 is electrically connected to the control circuit 21, the first sound transmission unit 24, and the second sound transmission unit 25 respectively. The switch unit 23 is also capable of either receiving the first switch signal from the control circuit 21 for enabling the first sound transmission unit 24 and disabling the second sound transmission unit 25 respectively or receiving the second switch signal from the control circuit 21 for disabling the first sound transmission unit 24 and enabling the second sound transmission unit 25 respectively.

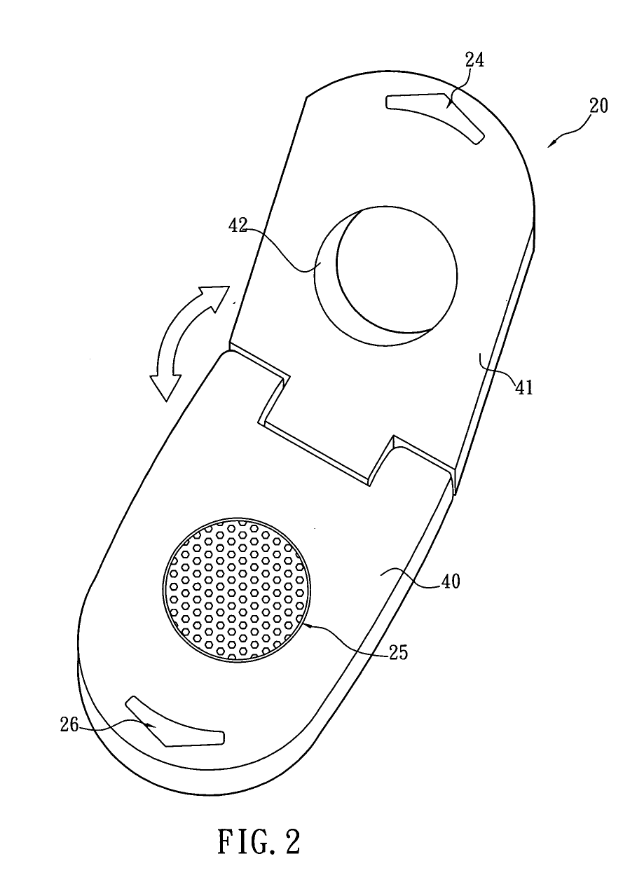

Referring to FIG. 1 again, in the invention the switch unit 23 is further capable of receiving a voice signal from the control circuit 21 (e.g., the running communication software receives a voice signal from another computer and sends same to the voice device 20) or an alert signal for the first sound transmission unit 24 or the second sound transmission unit 25 playing. The first sound transmission unit 24 is implemented as a small speaker. For example, the small speaker is one complying with the specifications of speaker mounted in an earphone (e.g., a small piezoelectric speaker having a diameter φ of about 10.0 mm). The first sound transmission unit 24 is electrically connected to the switch unit 23 such that the first sound transmission unit 24 is adapted to play voice after receiving voice signals. The second sound transmission unit 25 is implemented as a medium or large speaker (e.g., (φ of 30.0 mm). The second sound transmission unit 25 is electrically connected to the switch unit 23 such that the second sound transmission unit 25 is adapted to play corresponding sound (e.g., ring tone or buzzing sound) after receiving an alert signal. Referring to FIG. 2 again, in the embodiment of the invention the voice device 20 comprises a body 40 and a cover 41 hingedly connected to an upper end of the body 40. In use, the cover 41 is adapted to rest upon a top surface of the body 40 by pivoting. Thus, the voice device 20 is in a closed position (i.e., idle state). Alternatively, the cover 41 is adapted to dispose away from the top surface of the body 40 by pivoting in an opposing direction. Thus, the voice device 20 is in an open position (i.e., use state). The above components are mounted in both the body 40 and the cover 41. The voice device 20 can operate normally due to these components. Further, the sound receiving unit 26 is provided on the top surface of the cover 40 proximate its lower end (i.e., distal the upper end hingedly connected to the cover 41). The second sound transmission unit 25 is provided between the hinge and the sound receiving unit 26. The first sound transmission unit 24 is provided on an inner surface of the cover 40 facing the top surface of the body 40 (i.e., at a lower end of the cover 41 distal the upper end of the body 40 hingedly connected to the cover 41) when the voice device 20 is closed. Thus, the sensor unit 22 can be enabled to generate either a use signal in response to resting the cover 41 upon the body 40 by pivoting (i.e., the voice device 20 is closed) or an idle signal in response to pivoting the cover 41 away from the body 40 in an opposing direction (i.e., the voice device 20 is open).

Referring to FIG. 2 again, in the embodiment the cover 41 comprises an opening 42 conformed to the shape of the second sound transmission unit 25. The opening 42 can be shaped as a circle, a triangle, a star, or a cartoon figure so as to realize a diversified design of the cover 41 for being visually aesthetic. The opening 42 lines up with the second sound transmission unit 25 when the cover 41 closes onto the body 40. Thus, voice played by the second sound transmission unit 25 can freely pass the opening 42 to transmit beyond the top surface of the cover 41. Hence, the provision of the opening 42 aims at not only being visually aesthetic but also permitting voice to pass freely.

Referring to FIG. 2 again, in the embodiment a channel (not shown) is provided in an internal space of the cover 41 or on a surface of the cover 41. One end of the channel is disposed at a location where the first sound transmission unit 24 is mounted on the cover 41 so as to permit voice played by the first sound transmission unit 24 to pass. The other end of the channel is disposed on the top surface of the cover 41. Thus, voice played by the first sound transmission unit 24 can freely pass through the channel for hearing when the cover 41 closes onto the body 40.

In view of above, it is contemplated by the invention that the first sound transmission unit 24 is disposed in an optimum position relative to the ear and the sound receiving unit 26 is disposed in an optimum position relative to the mouth respectively so as not to interfere with conversation being made when the cover 41 is in an open position relative to the body 40. Further, both the body 40 and the cover 41 can be designed as one of a variety of shapes (e.g., animal figure or soccer). A diversified design of the voice device 20 is thus effected. As a result, more consumers may be willing to buy the voice device 20.

While the invention herein disclosed has been described by means of specific embodiments, numerous modifications and variations could be made thereto by those skilled in the art without departing from the scope and spirit of the invention set forth in the claims.

What is claimed is:

1. A voice device including a body and a cover hingedly connected to the body such that either resting the cover upon a top surface of the body by pivoting in a first direction will dispose the voice device in a closed position or opening the cover by pivoting in a second direction opposing the first direction will dispose the voice device in an open position, the voice device further comprising:
a first sound transmission unit mounted on the cover for playing voice;
a second sound transmission unit mounted on the body for playing an alert message;
a sensor unit for generating a use signal or an idle signal in response to a use state or an idle state of the voice device;
a control circuit electrically connected to the sensor unit and adapted to generate either a corresponding first switch signal in response to receiving the use signal or a corresponding second switch signal in response to receiving the idle signal;
a sound receiving unit electrically connected to the control circuit and adapted to receive voice from an external audio source and convert same into a voice signal prior to sending to the control circuit;
a transfer unit electrically connected to the control circuit; and
a switch unit electrically connected to the control circuit, the first sound transmission unit, the second sound transmission unit respectively, the switch unit being adapted to either enable the first sound transmission unit in response to receiving the first switch signal or enable the second sound transmission unit in response to receiving the second switch signal; and receive the voice signal from the control circuit or an alert signal prior to sending to the first sound transmission unit or the second sound transmission unit.

2. The voice device of claim 1, wherein the cover comprises an opening shaped to conform to the second sound transmission unit, the opening being aligned with the second sound transmission unit when the cover closes onto the body.

3. The voice device of claim 2, wherein the cover further comprises an internal channel having one end disposed at a location where the first sound transmission unit is mounted on the cover 41 for permitting voice played by the first sound transmission unit to pass, and the other end disposed on a top surface of the cover for permitting the played voice to transmit beyond the top surface of the cover.

4. The voice device of claim 3, wherein the sensor unit is a micro-switch, a rotatory sensor, or an optical sensor.

5. The voice device of claim 4, wherein the opening is shaped as a circle, a triangle, a star, or a cartoon figure.
